(19) United States
(12) Patent Application Publication
(10) Pub. No.: US 2015/0363595 A1
(43) Pub. Date: Dec. 17, 2015

(54) COMPUTER SECURITY MONITORING WITH TRIGGERED REPORTING

(71) Applicant: International Business Machines Corporation, Armonk, NY (US)

(72) Inventors: Amit Klein, Herzliya (IL); Shmulik Regev, Tel Aviv (IL)

(21) Appl. No.: 14/301,612

(22) Filed: Jun. 11, 2014

(51) Int. Cl. G06F 21/55; G06F 21/56

(52) U.S. Cl. CPC G06F 21/554; G06F 21/56; G06F 2221/034

(57) ABSTRACT

A computer security method including periodically recording a screenshot of what is displayed on a display of a computer, thereby recording a plurality of screenshots, selecting, in accordance with predefined selection criteria, any of the screenshots that were recorded near detection of a security-related condition, and providing any of the selected screenshots in association with the detection of the security-related condition.

### BACKGROUND OF THE INVENTION

The present invention relates generally to error detection and more particularly, to identification of actions leading to error events.

Malware is malicious software whose only purpose is to damage or perform other unwanted actions on computer systems. Generally, malware is any software used to disrupt computer operation, gather sensitive information, or gain access to private computer systems. Various forms of malware may allow individuals to, in a non-inclusive list, steal passwords and banking credentials; hack into social media accounts; access documents, photos, and other computer files; record keystrokes; activate webcams; hold a computer for ransom; and use the computer in distributed denial of service (DDoS) attacks. Malware can appear in the form of code, scripts, active content, and other software.

### SUMMARY

In one aspect of the invention a computer security method is provided, including periodically recording a screenshot of what is displayed on a display of a computer, thereby recording a plurality of screenshots, selecting, in accordance with predefined selection criteria, any of the screenshots that were recorded prior to detection of a security-related condition, and providing any of the selected screenshots in association with the detection of the security-related condition.

In other aspects of the invention, systems and computer program products embodying the invention are provided.

### BRIEF DESCRIPTION OF THE DRAWINGS

Aspects of the invention will be understood and appreciated more fully from the following detailed description taken in conjunction with the appended drawings in which:

FIG. 1 is a simplified conceptual illustration of a computer security system, constructed and operative, in accordance with an embodiment of the invention;

FIG. 2 is a simplified flowchart illustration of an exemplary method of operation of the system of FIG. 1, operative in accordance with an embodiment of the invention; and

FIG. 3 is a simplified block diagram illustration of an exemplary hardware implementation of a computing system, constructed and operative, in accordance with an embodiment of the invention.

### DETAILED DESCRIPTION

Embodiments of the present invention recognize that when a computer is attacked by, or infected with, malware, it is typically the result of an operation performed by a computer user, such as when the computer user uses a browser to visit a web page that contains an exploit kit, or opens an email message from an attacker, or an infected email from a known source, and clicks on an email attachment that is harboring the malware or on a link within the body of the email that links to a malicious web page. When investigating such an incident, it may be useful to understand the chain of events that preceded it in order to identify any actions that the user took, or failed to take, just prior to, or during, the incident. Towards that end, embodiments of the present invention provide techniques for assisting in the identification of such acts, primarily from the recordation of screenshots taken in temporal proximity to detection of a detected error or malfunction.

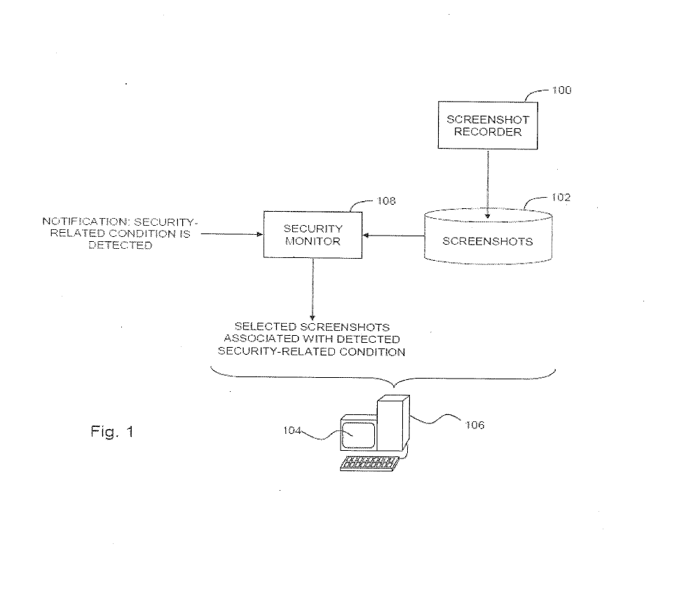

Reference is now made to FIG. 1, which is a simplified conceptual illustration of a computer security system, constructed and operative, in accordance with an embodiment of the invention. In the system of FIG. 1, a screenshot recorder 100 is configured to record screenshots 102 of what is displayed on a display 104 of a computer 106. Screenshots 102 may be recorded using any known technique, at predefined intervals, such as one per second, and at any predefined resolution, and may be stored using any known data storage technique.

The system of FIG. 1 also includes a security monitor 108 that is configured to select, in accordance with predefined selection criteria, any of screenshots 102 that were recorded around the time of the detection of a security-related condition, and provide the selected screenshots 102 in association with the detection of the security-related condition. The security-related condition may, for example, be the existence of malware or malware-related activity at computer 106, including attempts to infect computer 106 with a computer virus or anything else that is related to compromising the security of computer 106. Security monitor 108 preferably selects and provides the screenshots 102 in response to the detection of the predefined security-related condition, such as where security monitor 108 receives a notification that the security-related condition was detected. Such notifications may, for example, be sent by software that detects computer viruses, malware, and/or attempts to compromise computer security.

The predefined selection criteria that security monitor 108 uses to select screenshots 102 preferably indicates that a predefined number of screenshots 102 are to be selected in association with the detection of the security-related condition or that the selection is to include any of screenshots 102 that were recorded within a predefined time period relative to the time that the security-related condition was detected. The predefined selection criteria also preferably indicates whether the selection is to include any of screenshots 102 that were recorded before, during, and/or after the time that the security-related condition was detected.

Security monitor 108 is preferably configured to provide the selected screenshots 102 to a user or administrator of computer 106, preferably together with an indication that the selection is associated with the security-related condition that was detected.

Any of the elements shown in FIG. 1 are preferably implemented by one or more computers, such as by computer 106, in computer hardware, and/or in computer software embodied in a computer readable storage medium in accordance with conventional techniques.

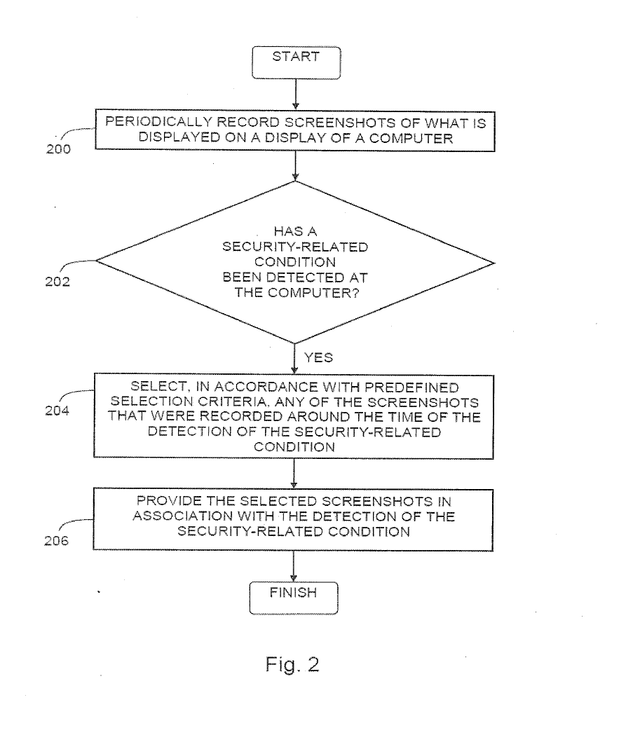

Reference is now made to FIG. 2, which is a simplified flowchart illustration of an exemplary method of operation of the system of FIG. 1, operative, in accordance with an embodiment of the invention. In the method of FIG. 2, screenshots are periodically recorded of what is displayed on a display of a computer (step 200). If a security-related condition at the computer is detected (step 202), a selection is made in accordance with predefined selection criteria of any of the screenshots that were recorded around the time of the detection of a security-related condition (step 204), and the selected screenshots are provided in association with the detection of the security-related condition (step 206), such as to a user or administrator of the computer, and where the selected screenshots are provided together with an indication that the selection is associated with the security-related condition that was detected. As used herein, a “user” of the computer includes an administrator of the computer.

The system of FIG. 1 and method of FIG. 2 may be illustrated in the context of the following exemplary scenario in which:
screenshots of the display of a computer are taken once every five seconds;
a security-related condition is detected at the computer, where the security-related condition is an attempt by malware to attack the computer;
the screenshots that were recorded in the two minutes before the security-related condition was detected are selected;
the selected screenshots are provided to the user of the computer together with a notification indicating that an attempt by malware to attack the computer was detected.

In one embodiment of the invention, the most recent N screenshots, such as where N=10 and is user-configurable, are kept in computer memory (RAM) in order to minimize impact on the performance of the system. In this embodiment, only when a security-related condition is detected are the screenshots saved to non-volatile storage, such as to a magnetic or optical disk, and/or transmitted via a network, such as to a system administrator. Additionally or alternatively, the screenshots are compressed using conventional lossless or lossy techniques, are stored at a low resolution, and/or are stored in grey scale or black-and-white format. Screenshots may also be compressed using conventional frame-to-frame differential techniques, as they represent the computer's display data over a time continuum.

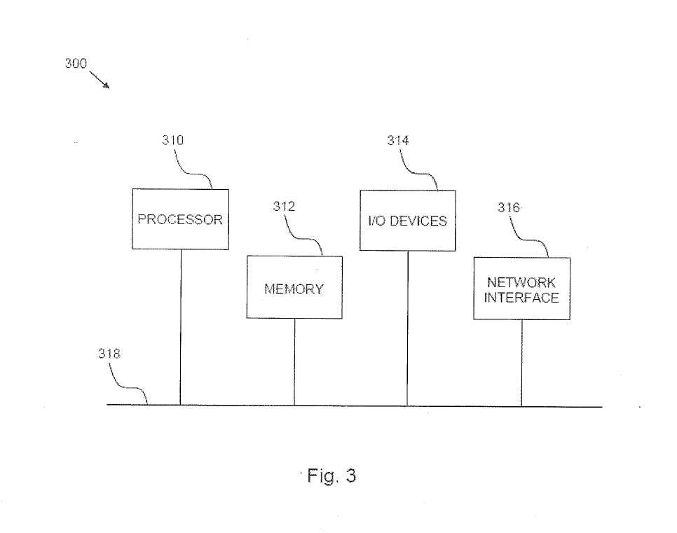

Referring now to FIG. 3, block diagram 300 illustrates an exemplary hardware implementation of a computing system in accordance with which one or more components/methodologies of the invention (e.g., components/methodologies described in the context of FIGS. 1-2) may be implemented, according to an embodiment of the invention.

As shown, the techniques for controlling access to at least one resource may be implemented in accordance with a processor 310, a memory 312, I/O devices 314, and a network interface 316, coupled via a computer bus 318 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

Embodiments of the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Ruby, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer security method comprising:
periodically recording a screenshot of what is displayed on a display of a computer, thereby recording a plurality of screenshots;
detecting, by one or more computer processors, a security-related condition;
in response to detecting the security-related condition, selecting, in accordance with predefined selection criteria, one or more screenshots, of the plurality of screenshots, that were recorded near detection of the security-related condition; and
associating one or more of the selected screenshots with the detected security-related condition.

2. The method of claim 1, further comprising:
storing the associated one or more selected screenshots and the detected security-related condition for subsequent analysis.

3. The method of claim 1, further comprising:
providing the associated one or more selected screenshots and the detected security-related condition to a user of the computer.

4. The method of claim 1, wherein the security-related condition is detection of malware or malware-related activity at the computer.

5. The method of claim 1, wherein selecting, in accordance with predefined selection criteria, one or more screenshots, of the plurality of screenshots, that were recorded near the detection of the security-related condition, comprises one or more of:
selecting one or more screenshots that were recorded prior to the detection of the security-related condition;
selecting one or more screenshots that were recorded during the detection of the security-related condition; and
selecting one or more screenshots that were recorded subsequent to the detection of the security-related condition.

6. The method of claim 1, wherein the predefined selection criteria includes a predefined time period, relative to when the security-related condition was detected, from which to select screenshots.

7. The method of claim 1, wherein the predefined selection criteria includes a predefined number of the screenshots.

8. A computer program product comprising:
one or more computer readable storage media; and
program instructions stored on the one or more computer readable storage media, the program instructions comprising:
program instructions to periodically record a screenshot of what is displayed on a display of a computer, thereby recording a plurality of screenshots;
program instructions to detect a security-related condition;
program instructions to, in response to detecting the security-related condition, select, in accordance with predefined selection criteria, one or more screenshots, of the plurality of screenshots, that were recorded near detection of the security-related condition; and
program instructions to associate one or more of the selected screenshots with the detected security-related condition.

9. The computer program product of claim 8, further comprising program instructions, stored on the one or more computer readable storage media, to:
store the associated one or more selected screenshots and the detected security-related condition for subsequent analysis.

10. The computer program product of claim 8, further comprising program instructions, stored on the one or more computer readable storage media, to:
provide the associated one or more selected screenshots and the detected security-related condition to a user of the computer.

11. The computer program product of claim 8, wherein the security-related condition is detection of malware or malware-related activity at the computer.

12. The computer program product of claim 8, wherein the program instructions to select, in accordance with predefined selection criteria, one or more screenshots, of the plurality of screenshots, that were recorded near the detection of the security-related condition, comprises one or more of:
program instructions to select one or more screenshots that were recorded prior to the detection of the security-related condition;
program instructions to select one or more screenshots that were recorded during the detection of the security-related condition; and
program instructions to select one or more screenshots that were recorded subsequent to the detection of the security-related condition.

13. The computer program product of claim 8, wherein the predefined selection criteria includes a predefined time period, relative to when the security-related condition was detected, from which to select screenshots.

14. The computer program product of claim 8, wherein the predefined selection criteria includes a predefined number of the screenshots.

15. A computer system comprising:
one or more computer processors;
one or more computer readable storage media; and
program instructions stored on the one or more computer readable storage media for execution by at least one of the one or more computer processors, the program instructions comprising:
program instructions to periodically record a screenshot of what is displayed on a display of a computer, thereby recording a plurality of screenshots;
program instructions to detect a security-related condition;
program instructions to, in response to detecting the security-related condition, select, in accordance with predefined selection criteria, one or more screenshots, of the plurality of screenshots, that were recorded near detection of the security-related condition; and
program instructions to associate one or more of the selected screenshots with the detected security-related condition.

16. The computer system of claim 15, further comprising program instructions, stored on the one or more computer readable storage media for execution by at least one of the one or more computer processors, to:
store the associated one or more selected screenshots and the detected security-related condition for subsequent analysis.

17. The computer system of claim 15, further comprising program instructions, stored on the one or more computer readable storage media for execution by at least one of the one or more computer processors, to:
provide the associated one or more selected screenshots and the detected security-related condition to a user of the computer.

18. The computer system of claim 15, wherein the security-related condition is detection of malware or malware-related activity at the computer.

19. The computer system of claim 15, wherein the program instructions to select, in accordance with predefined selection criteria, one or more screenshots, of the plurality of screenshots, that were recorded near the detection of the security-related condition, comprises one or more of:
program instructions to select one or more screenshots that were recorded prior to the detection of the security-related condition;
program instructions to select one or more screenshots that were recorded during the detection of the security-related condition; and
program instructions to select one or more screenshots that were recorded subsequent to the detection of the security-related condition.

20. The computer system of claim 15, wherein the predefined selection criteria includes a predefined time period, relative to when the security-related condition was detected, from which to select screenshots.
